(19) United States
(12) Patent Application Publication
(10) Pub. No.: US 2017/0169132 A1
(43) Pub. Date: Jun. 15, 2017

(54) ACCELERATED LOOKUP TABLE BASED FUNCTION EVALUATION

(71) Applicant: ANALOG DEVICES, INC., Norwood, MA (US)

(72) Inventors: DAVID M. HOSSACK, SOMERVILLE, MA (US); TIMOTHY J. CAPUTO, NEWTON, MA (US)

(73) Assignee: ANALOG DEVICES, INC., Norwood, MA (US)

(21) Appl. No.: 14/970,148

(22) Filed: Dec. 15, 2015

(51) Int. Cl. G06F 17/30

(52) U.S. Cl. CPC G06F 17/30952; G06F 17/30324

(57) ABSTRACT

Present disclosure aims to accelerate computer-implemented function evaluation by accelerating determination of a table index and a fraction required for interpolation when a processor uses lookup table based function approximation to compute a function of a particular input value. Systems and methods proposed herein are based on an insight that, by carefully selecting configuration for a lookup table used for function approximation, it is possible to reduce determination of table index and fraction to simple shifting of bits of an input value. Once table index and fraction are determined according to systems and methods proposed herein, the value of the function for the given input value may be computed as known in the art.

### TECHNICAL FIELD OF THE DISCLOSURE

The present disclosure relates to computing, in particular to systems and methods for accelerating lookup table based function evaluation.

### BACKGROUND

Many applications require mathematical functions to be evaluated millions of times a second. As used herein, the term “function” is used to describe a mathematical relation that allows processing one or more numerical inputs to return one or more numerical outputs. Configuring processors of computing devices with instructions to compute various functions, from multiplication and division to nonlinear functions such as e.g. trigonometric functions, square roots, reciprocals, and reciprocal square roots, is not a trivial task.

In general, functions can be represented by some sort of polynomial approximation, e.g. a Taylor series, which requires a processor to evaluate many instructions to calculate the value a polynomial. Functions are often defined as a composition of other functions and are evaluated using multiple function evaluations. Oftentimes, computers use software running on a general-purpose central processing unit (CPU) to evaluate functions. To speed up function evaluation, in place or in addition to software-based processing, it is possible to implement some commonly used functions such as e.g. sine, cosine, tangent, square-root, and so on, directly in computer hardware, a process commonly known as “hardware acceleration.” In such cases, the processor can directly evaluate the function using a single instruction that executes far quicker than the sequence of instructions that would be required if only the software was used.

One problem with hardware acceleration arises from the fact that including each hardware accelerator takes up valuable space on an Integrated Circuit (IC) chip and increases power consumption, adding cost to the design and to operation of the final chip. Another problem is that, in order for a function to be implemented in hardware on a chip, the designers need to know, at the design time, which functions are to be hardware accelerated. Therefore, hardware acceleration is typically only suited for commonly used functions.

Since function evaluation is an important area of computing, systems and methods that can accelerate the process are always desired.

### OVERVIEW

One aspect of the present disclosure provides an apparatus for at least determining a table index (indicated herein as “i” or “index”) and a fraction (indicated herein as “f” or “fraction”) to be used in computing a function of an input variable (x) using a lookup table. The apparatus includes a logic for receiving the input variable, configuration information for the lookup table, and a memory address of a predefined reference point within the lookup table; a logic for sign extending the input value; a logic for zero padding the input value for the input value to be a binary value comprising a predefined number of bits; a logic for using the configuration information to determine a first number of bits to shift a binary representation of the input variable to determine the table index; a logic for using the configuration information to determine a second number of bits to shift the binary representation of the input variable to determine the fraction; one or more shifters for shifting the binary representation of the input variable by the first number of bits to determine the table index and for shifting the binary representation of the input variable by the second number of bits to determine the fraction; a logic for using the memory address of the predefined reference point and the determined table index to determine a memory address from which a table value for computing the function is to be obtained; and a logic for providing as an output the memory address from which the table value for computing the function is to be obtained and the fraction.

As used herein, “sign extending” refers to adding bits to the “left” of a data word, i.e. to the most significant bit (MSB) end, that match the most significant given bit (also the sign bit) of a signed number in twos complement representation and does not change the number being represented.

As used herein, “zero padding” refers to representing a binary value in a form that the value has a predefined, fixed, number of bits by adding zero bits at the least significant end of the binary number beyond the binary point.

Another aspect of the present disclosure provides another apparatus for at least determining a table index and a fraction to be used in computing a function of an input variable (x) using a lookup table. The apparatus may include a logic for receiving the input variable; a logic for, following receipt of the input variable, obtaining configuration information for the lookup table to be used for computing the function of the input variable; a logic for using the configuration information to determine a first number of bits to shift a binary representation of the input variable to determine the table index; a logic for using the configuration information to determine a second number of bits to shift the binary representation of the input variable to determine the fraction; and one or more shifters for shifting the binary representation of the input variable by the first number of bits to determine the table index and for shifting the binary representation of the input variable by the second number of bits to determine the fraction.

Corresponding methods are also disclosed.

One method includes receiving the input variable, configuration information for the lookup table, and a memory address of a predefined reference point within the lookup table; sign extending the input value; zero padding the input value for the input value to be a binary value comprising a predefined number of bits; using the configuration information to determine a first number of bits to shift a binary representation of the input variable to determine the table index; using the configuration information to determine a second number of bits to shift the binary representation of the input variable to determine the fraction; shifting the binary representation of the input variable by the first number of bits to determine the table index and for shifting the binary representation of the input variable by the second number of bits to determine the fraction; using the memory address of the predefined reference point and the determined table index to determine a memory address from which a table value for computing the function is to be obtained; and providing as an output the memory address from which the table value for computing the function is to be obtained and the fraction.

Another method includes obtaining configuration information for the lookup table; using the configuration information to determine a first number of bits to shift a binary representation of the input variable to determine the table index; using the configuration information to determine a second number of bits to shift the binary representation of the input variable to determine the fraction; and shifting the binary representation of the input variable by the first number of bits to determine the table index and for shifting the binary representation of the input variable by the second number of bits to determine the fraction.

As will be appreciated by one skilled in the art, aspects of the present disclosure may be embodied in various manners—e.g. as a method, a system, a computer program product, or a computer-readable storage medium. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more processing units, e.g. one or more microprocessors, of one or more computers. In various embodiments, different steps and portions of the steps of each of the methods described herein may be performed by different processing units. Furthermore, aspects of the present disclosure may take the form of a computer program product embodied in one or more computer readable medium(s), preferably non-transitory, having computer readable program code embodied, e.g., stored, thereon. In various embodiments, such a computer program may, for example, be downloaded (updated) to the existing devices and systems (e.g. to the existing processors, microprocessors, etc.) or be stored upon manufacturing of these devices and systems.

Other features and advantages of the disclosure are apparent from the following description, and from the claims.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a diagram illustrating a system configured to determine table index and fraction, according to some embodiments of the present disclosure;

FIG. 2 is a diagram illustrating a computer system configured to implement various functionality related to configured to determination of table index and fraction, according to some embodiments of the present disclosure;

FIG. 3 is a flow diagram of method steps illustrating determination of table index and fraction, according to some embodiments of the present disclosure;

FIGS. 4A and 4B illustrate a range of inputs starting from zero and centered around zero, respectively, according to some embodiments of the present disclosure;

FIG. 5 illustrates clipping of function values for input values that are out of range, according to some embodiments of the present disclosure;

FIG. 6 illustrates an example of selecting bits from a binary representation of an input value to determine index and fraction, according to some embodiments of the present disclosure;

FIG. 7 provides a further illustration for the example input value shown in FIG. 6, according to some embodiments of the present disclosure;

FIG. 8 is a flow diagram illustrating an exemplary computer system architecture configured to provide table address and fraction, according to some embodiments of the present disclosure;

FIG. 9 is a flow diagram illustrating an exemplary computer system architecture configured to provide table index and fraction, according to some embodiments of the present disclosure; and

FIG. 10 is a flow diagram illustrating an exemplary computer system architecture illustrating clamp detection and clamp multiplexing, according to some embodiments of the present disclosure.

### DESCRIPTION OF EXAMPLE EMBODIMENTS OF THE DISCLOSURE

### Basics of Microprocessor Architecture

Microprocessors are often used in applications where mathematical functions need to be evaluated. This allows hardware to execute algorithms that are under software control.

A microprocessor operates by executing a sequence of instructions. These instructions are typically very basic such as load value from memory, store value to memory, add, subtract numbers, compare numbers and conditionally jump to a different sequence of instructions.

Microprocessors for signal processing applications are often extended to be efficient in performing digital signal processing operations by including multipliers and other arithmetic circuits. A further improvement in performance is gained by using Single Instruction Multiple Data (SIMD) architecture, where the processor performs the same operation on multiple pieces of data at the same time. For example, a processor may perform two multiplications on two pairs of data values at the same time. However even with these extensions, function evaluation can take up a significant proportion of the total execution time.

The hardware is often designed and implemented well before the application problem and application solutions have been determined. Therefore, the hardware is often designed to be sufficiently general purpose to enable future unknown applications.

If the function to be evaluated cannot be represented in terms of functions that hardware is designed to directly accelerate, then it must be evaluated in terms of very basic instructions. Often this requires the processor to make branches depending on the input value. If the function is defined over a range of inputs and the input value is outside this range, then this needs to be detected, typically using conditional branches.

One disadvantages of using branches is that the time taken for function evaluation varies according to the input value, which makes scheduling real time algorithms more difficult and limits performance by using the worst-case time limits. Another disadvantage is that branches often have a significant performance penalty in modern deeply pipelined implementations.

### Lookup Table Based Function Evaluation

It is possible to store pre-computed function values in a table, commonly referred to as a “lookup table,” and return the appropriate table value when evaluating the function. Storing every possible output value corresponding to every possible input value often requires excessive amount of memory, so interpolation is typically used, with function evaluation comprising looking up certain values in a table and interpolating between them. In such a case, the function evaluation procedure includes finding appropriate values in the table by determining the table index of at least one of two or more adjacent values to be used for interpolation, determining the fraction indicating weights to be used for the interpolation between these values, obtain the values using the determined table index, and then perform the interpolation of the obtained values using the determined fraction to recover an approximation to the desired function.

Determining the table index and the fraction necessary to perform table lookup for a given input value can be mathematically very simple, but may require many instructions to be performed.

Consider a lookup table that includes N points xᵢ, where i is the index of a point in the table and the points of the lookup table are equally spaced. For a given input variable x, the table index to be used may be calculated using an equation such as:

$$\begin{matrix}i ( x ) = floor ( \frac{x - {x}_{0}}{{x}_{spacing}} ) \\ where & ( 1 ) \\ {x}_{spacing} = \frac{{x}_{N} - {x}_{0}}{N} & ( 2 )\end{matrix}$$

and “floor” refers to the floor function that outputs the nearest integer down (e.g. “floor” of 5.45 is 5, while “floor” of 10.21 is 10).

However this will only work when the input variable x is within the range of the tabulated values, i.e. when x₀≦x<x_{N}, so that the index i is within the table, i.e. 0≦i(x)<N

The fraction for performing the interpolation using the table value indexed with the index computed according to (1) may then be calculated as follows:

$$f ( x ) = \frac{x - i ( x ) {x}_{spacing}}{{x}_{spacing}} \qquad ( 3 )$$

with 0≦f(x)<1 and assuming that x₀≦x<x_{N}.

### Acceleration of Lookup Table Based Function Evaluation

Present disclosure aims to accelerate computer-implemented function evaluation by accelerating determination of a table index and a fraction required for interpolation when a processor uses lookup table based function approximation to compute a function of a particular input value. Systems and methods proposed herein are based on an insight that, by carefully selecting configuration for a lookup table used for function approximation, it is possible to reduce determination of table index and fraction to simple shifting of bits of an input value. Once table index and fraction are determined according to systems and methods proposed herein, the value of the function for the given input value may be computed as known in the art.

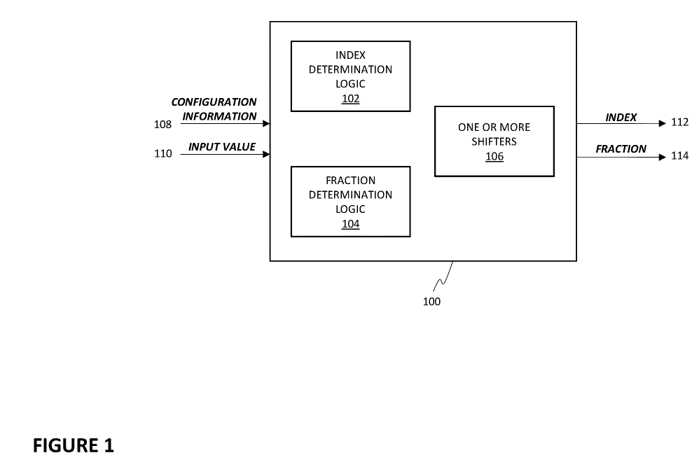

In one aspect, the proposed solution includes adding a functional module, which could be implemented in hardware, software, firmware, or any combination thereof, that accelerates lookup table based function approximation. Given an input value and configuration information that describes configuration of a lookup table to be used, the module may then calculate the index, and, optionally, the address in memory, of the relevant value(s) of the table (in the following: “index”), as well as the fraction required for interpolation (in the following: “fraction”). FIG. 1 is a diagram illustrating one example of such a functional module shown as system 100.

As shown in FIG. 1, the system 100 includes at least an index determination logic 102, a fraction determination logic 104, and one or more shifters 106. The system 100 is configured to obtain configuration information, as shown with an arrow 108, and an input value for which value of a particular function is to be computed, as shown with an arrow 110. The system 100 is then configured to output an indication of a table index, as shown with an arrow 112, and an indication of a fraction, as shown with an arrow 114, to be used for computing the value of the function for the input value 110.

In various embodiments, the system 100 may include further elements not shown in FIG. 1. For example, the system 100 may further include various databases, e.g. for storing input values, results of intermediate computations, and/or final results. To that end, the system 100 may include any memory such as, but not limited to, hardware registers, cache memory, system memory, processors state condition codes, external storage, or any other types of available destinations for processor instructions. In another example, the system 100 may further include logic (not shown in FIG. 1) for performing additional, optional, functionality described herein, such as e.g. logic for determining memory address of a table value to be used for computing the function, logic for presenting the determined fraction in different representations, logic for determining whether the input value is within the range of the lookup table and identifying actions regarding function evaluation based on whether the input value is within the range.

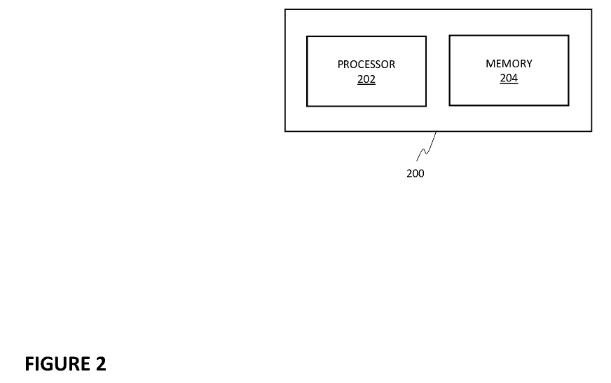

FIG. 2 is a diagram illustrating a computer system 200 configured to implement various functionality related to determination of table index and fraction, according to some embodiments of the present disclosure. As shown in FIG. 2, the system 200 may include at least a processor 202 and a memory 204 configured to implement various steps and features described herein. Any of the logics described herein, e.g. the index determination logic 102, the fraction determination logic 104, etc., or any combination thereof, may be implemented as the system 200.

The memory 204 could comprise any memory element suitable for storing information, such as e.g., random access memory (RAM), read only memory (ROM), an erasable programmable read only memory (EPROM), application specific integrated circuit (ASIC), etc. Any of the memory items discussed herein should be construed as being encompassed within the broad term “memory element.” The information being tracked or sent to the logic and systems described herein, such as e.g. to the logic 102, 104 106, and the systems 100 and 200, could be provided in any database, register, control list, cache, or storage structure, all of which can be referenced at any suitable timeframe. Any such storage options may be included within the broad term “memory element” as used herein. Similarly, any of the potential processing elements, modules, and machines described herein should be construed as being encompassed within the broad term “processor,” e.g. processor 202.

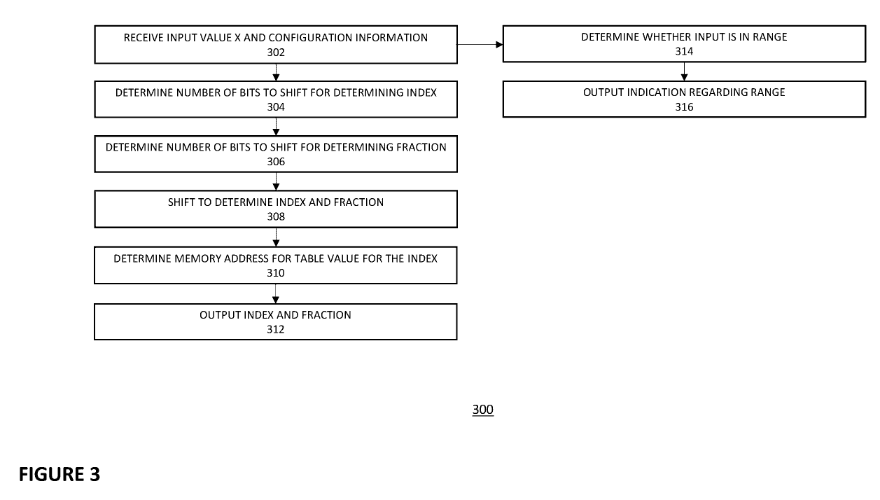

FIG. 3 is a flow diagram 300 of method steps illustrating determination of table index and fraction, according to some embodiments of the present disclosure. While method 300 is described with reference to the system 100 shown in FIG. 1, any system configured to perform these methods, in any order, is within the scope of the present disclosure.

The method may begin with step 302, where the system 100 receives configuration information 108 for the lookup table, e.g. from a register, as well as an input value x 110 for which a corresponding index and fraction in the lookup table is to be determined. The configuration information and the input value may be provided to each of the index determination logic 102 and the fraction determination logic 104.

In an embodiment, the configuration information 108 may include an indication of bits to be extracted from the binary representation of the input variable x in order to determine the table index (i.e. an indication of a number of bits and their position within the binary representation) and an indication of bits to be extracted from the binary representation of the input variable in order to determine the fraction (again, the indication of a number of bits and their position within the binary representation). In various embodiments, the configuration information may further include an indication of a number of fractional bits to be used for determining the fraction (which would provide an indication as to how many bits are to be zero-padded, as described below), an indication as to how to determine whether the input value is outside of the range of the input variables of the lookup table, an indication whether the function is to be periodically extended outside of the range, an indication whether the function is to be clipped outside of the range, an indication of an amount of memory space allocated for storing each table entry, and/or a format indicating how the fraction is to be presented at the output.

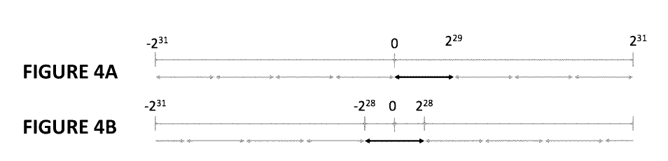

In some embodiments, the configuration information may also include an indication of whether a range of input variables of the lookup table includes only positive input values or whether the range is centered around zero. FIG. 4A illustrates a range of inputs starting from zero to some power of 2 (in the example shown in FIG. 4A, to 2²⁹, i.e. x₀=0 and x_{N}=2²⁹). FIG. 4B illustrates a range of inputs centered on zero (in the example shown in FIG. 4B, x₀=−2²⁸ and x_{N}=2²⁸), so the range of inputs is the same as in FIG. 4A, 2²⁹. Of course, in various embodiments, any other power of two could be implemented.

For example, in some embodiments, parameters representing some or all of x₀, x_{N}, N, table_start_address maybe encoded in a machine word (or more than one) and provided as a configuration information input to the table_index instruction implemented by the system 100. When evaluating a function for many different values of x, these values do not change, and so this adds configuration options to the instruction without significant overhead. Further options can encode into the configuration information e.g. what to do when the input is out of range, and whether the table values include negative numbers (e.g. whether x₀ is negative).

In an embodiment, the configuration information may be encoded within a bit word of a certain length, e.g. in a 32 bit word, and include the number of bits of the input x that are extracted to form the fraction, the number of bits that are extracted to form the index, whether the x₀ is 0 or −x_{N} (whether the function input range is positive only or is centered around zero), whether the function should be periodically extended outside the principal range or whether the index and fraction should be set to the values corresponding to ends of the valid input range, the value of table_entry_size, and the format describing how the fraction information should be returned.

In various embodiments, the input value could be presented in any form—e.g. be a floating point number, or a fixed point number.

In step 304, the index determination logic 102 uses the received configuration information to determine a number of bits by which a binary representation of the input value is to be shifted in order to determine index in the lookup table that corresponds to the function value for the input value.

In step 306, the fraction determination logic 104 uses the received configuration information to determine a number of bits by which a binary representation of the input value is to be shifted in order to determine fraction to be used for computing the function value for the input value. In various embodiments, steps 304 and 306 may be performed at any time with respect to one another—e.g. simultaneously, step 306 being performed first, in time periods that are overlapping, etc.

In some embodiments, a single instruction can perform calculation of both the index and fraction.

The index determination logic 102 and the fraction determination logic 104 are configured to provide results of their computations in steps 304 and 306 to the one or more shifters 106 which may then shift the binary representation of the input value x by the determined number of bits, in the correct direction, to determine the index and the fraction.

In general, the term “shifter” (also sometimes referred to as a “barrel shifter”), e.g. the shifter 106, refers to a circuit, typically implemented in hardware, configured to receive a data word as an input and shift the data word by a specified number of bits in one clock cycle, referred to as a “shift value.” The shifted data word is then provided as an output of the shifter: data_out[i]=data_in[i-shift]. In some embodiments, the shift value may be pre-defined. In other embodiments, the shift-value may be provided to the shifter as an input.

In some embodiments, the shift value is a digital word than can be selected from a predefined range, e.g. a four bit number with shifts of zero to fifteen.

In various embodiments, the shift value maybe positive, negative or zero.

In various embodiments, the number of bits of the input data work does not need to match the number of bits of the output.

Conceptually and practically, an input word can be widened to ensure that there is always a defined input bit as required. When the required bit has lower significance than any bit of the input data work, that bit can be assumed to be zero. When the required bit has higher significance than any bit of the input data work, then that bit can be assumed to be the same as most significant bit that is supplied (assuming a two's complement representation).

Adding zero bits to the “right” of a data word, i.e. to the least significant bit (LSB) end of the data word, doesn't change the value represented if there is a defined place for the binary point. For example, 11.0 represents the same number as 11.000. Making a word wider by augmenting with zeros is typically referred to as “zero padding.”

Adding bits to the “left” of a data word, i.e. to the most significant bit (MSB) end, that match the most significant given bit (also the sign bit) also does not change the number being represented. For example, 011 is the same as 00011 and 101 represents the same value as 11101 when using two's complement representation. Making a word wider by replicating the sign bit is typically referred to as “sign extension.”

Since a shifter is selecting the appropriate input bits to form the output word, the shifter may be implemented using digital multiplexer components.

In step 310, the system 100 is configured to determine memory address for the table value based on the index computed in step 310. In an embodiment, the memory address of step 310 may be determined with respect to a predefined reference point in memory, such as e.g. a starting value of the lookup table (i.e. the memory address is then the address for the first value of the lookup table, from which addresses of all of the subsequent values may be calculated using the index). In an embodiment, the memory address of the predefined reference point within the lookup table may be provided to the system 100 from one or more registers.

In an embodiment, the system 100 is configured to determine the memory address for the table value using an indication of an amount of memory space allocated for storing each table entry that the system 100 could have received as a part of the configuration information. This may be carried out according to equation (4):

address=table_start_address+index*table_entry_size (4)

In step 312, the system 100 outputs determined index and fraction, and possibly the memory address for the index. If configuration information provided to the system 100 included an indication of a format in which the fraction is to be presented at the output, then the system 100 may be configured to present the determined fraction in this format.

In some embodiments of step 312, the system 100 may be configured to return the values of index and fraction in a form suitable for direct use by an algorithm performing the lookup table based function evaluation. For example, the value of index may be scaled by the table entry size and added to table_address to directly give the location in memory of the indexed table values. The fraction may be return in forms such as 1-fraction or -fraction or in several forms. The reference implementation returns fraction in a form suitable for the processor's SIMD instructions.

In some embodiments, the system 100 may be configured to output the fraction in multiple representations, suitable for various subsequent processing of that value. For example, one representation could be a representation of a fraction to be used in computing the function of the input variable using a table value of the lookup table indexed by the determined index, while another representation could provide a fraction to be used in computing the function of the input variable using a table value of the lookup table immediately following or immediately preceding the table value indexed by the determined index.

Often, the range of input values that are of interest is limited and does not cover the entire numeric range of the input representation. To save the memory for the unwanted table entries, the numeric range of a lookup table can be limited. In this case, it is possible that the input value received by the system 100 is out of range, and consideration needs to be given to what to do with out-of-range inputs.

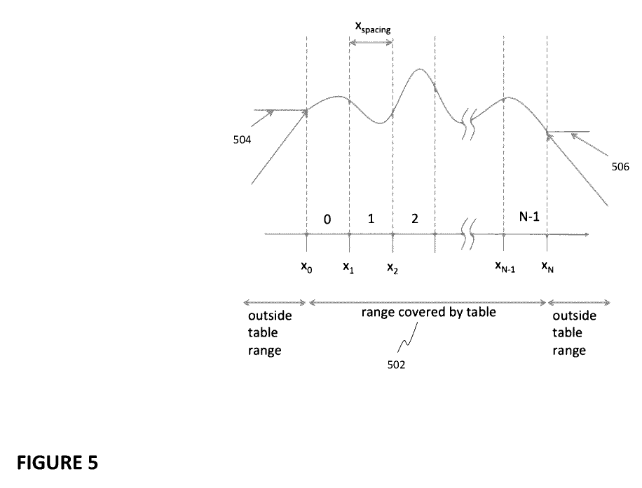

One option may be for the system 100 to clamp the output to the values associated with the lowest or highest in range input value, as illustrated in FIG. 5 showing that, for input values x that are outside of range 502 covered by table, the function may be clipped. In particular, FIG. 5 illustrates that, for input values x that are below the lowest in-range value x₀, the function is clipped to a value 504 that is the same as the lowest in-range value, while, for input values x that are above the highest in-range value x_{N}, the function is clipped to a value 506 that is the same as the highest in-range value.

Another option may be for the system 100 to periodically extend the range, which is suitable for periodic functions. Therefore, in some embodiments, the system 100 may also be configured to perform, optionally, steps 314 and 316 shown in FIG. 3. In such embodiments, following receipt of the input value and the configuration information, the system 100 may be configured to determine whether the input value x is within the range of input variables of the lookup table (step 314) and output a result of such determination (step 316). For example, the system 100 may be configured to provide an indication when the input variable is determined to be outside of the range and the function is not to be periodically extended outside of the range, and/or provide an indication on computing a value to be used in computing the function based on the determined table index when the input variable is determined to be outside of the range and the function is to be periodically extended outside of the range.

In some embodiments, the system 100 may further be configured to also compute the function using the determined table index and fraction. In some embodiments, the table values stored in the lookup table may be pre-computed. Alternatively the table values need not be pre-computed and could be computed as a separate part of the application, and the system 100 may also be configured to dynamically populate the lookup table with values. In some embodiments, the table may not directly store function values, but coefficients that are used for some approximation methods.

Techniques described herein enable efficient hardware implementation based on realization that, if the parameters x₀, x₁, N are chosen carefully, then the division and floor operations required to obtain the index i can be replaced by a right shift. Also, in this case the fraction f maybe calculated using Boolean operations on the binary representation of x. Two simple options for ensuring easy hardware implementations are for x₀ to zero, or for −x₀=x_{N} and for x_{N} to be a power of two and the number of points N to be a power of two.

In some embodiments, the system 100 may be configured to implement the same instruction for multidimensional tables, i.e. for functions that are functions of more than one variable. For example, by using currying, a function of two variables may be represented as a function of first variable that returns a function of the second variable. This may be implemented by making each table entry corresponding to the first variable, which may itself be a table that is used by a second table_index instruction using the second variable.

In some embodiments, the system 100 may be configured to use multiple tables, one for each output, and use multiple uses of the instruction and interpolation procedures, thereby being able to accommodate functions that return multiple outputs.

One advantage of the techniques described herein includes the fact that the lookup table can be held in conventional addressable memory. This allows multiple tables to be stored representing different functions and allows the size of table to be adjusted according to the accuracy requirements. In some embodiments, a designated table memory could also be used. Other advantages include ability to make calculations of the index and fraction simultaneously with a single instruction, ability to reuse the existing load from memory mechanisms provided by the base instruction set (thus simplifying the design and making it less expensive), significantly decreasing the time taken to evaluate a function. In addition, techniques described herein are deterministic because there is no need for branch instructions. Still another advantage is that the implementation is simple and does not need to redundantly duplicate existing functionality—e.g. the load store mechanism and the multipliers used for interpolation. If desired, the system 100 could be configured to perform the memory reads. If desired, the system 100 could perform the calculation required for interpolation. Yet another advantage is that out of range inputs can be directly accommodated without requiring extra program code or instruction execution time. If desired, out of range inputs may be signaled with the setting of a Boolean flag, or causing a processor exception.

The following section describes a specific example to illustrate functionality of the system 100 described above.

### An Illustrative Example

Consider an example of a lookup table including 8 points (i.e. N=8) with x values in the range from x₀=0 to x_{N}=4096. In such a case, x_{spacing} may be computed, according to equation (2) to be 512 (i.e. 512=(4096−0)/8) and consider that index i and fraction f are to be determined for a particular input, x=1999. In such an example, the index may be calculated, in accordance with equation (1) as index=floor((1999-0)/512)=3, and the fraction may be calculated, in accordance with equation (3) as fraction=(1999-3*512)/512=463/512=0.904296875.

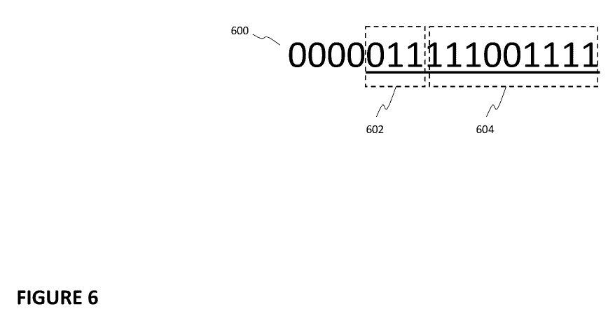

Continuing with this example, consider the 16 bit binary representation of the input value of x=1999, which is shown in FIG. 6 as a value 600. In FIG. 6, the underline denotes those bits that represent the number within the range x₀ to x_{N}. The most significant 3 bits of the underlined portion is “011_{binary}” (indicated as a portion 602 in FIG. 6) and gives the value of i directly, and the remaining least significant bits (indicated as a portion 604 in FIG. 6) give a representation of f: “111001111_{binary}”=463.

The unused MSBs can be examined to ensure that the number is within range. In this example, the MSBs are 0000_{binary}, which means that the input value 1999 is within the valid range. Any number other than 0000_{binary} would indicate that the input value was larger than x_{N}. This is a simple test for the hardware to perform. This can be extended to handle the case where the input is a signed two's complement number and the valid range is centered around zero and includes negative numbers. In this case, the MSBs must be either be all zero or all ones and this must match the MSB of the field extracted for i. If these conditions are not met, the input is out of range and the system 100 may be configured to take an appropriate action.

The system 100 may be configured so that the number of bits taken for index and the fraction is programmable.

The system 100 may be configured so that the representation off would remain fixed when the values of x₀, x_{N} and N are changed. This could involve a left shift and the addition of binary point. In the example described above, with 16 bit arithmetic and a two complement signed fixed point representation with 15 fractional bits (a conventional representation) this would be 0.111001111000000_{binary}.

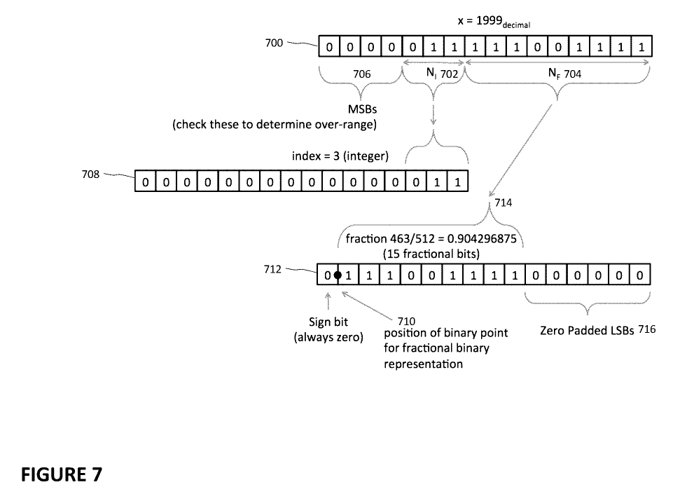

FIG. 7 provides another illustration of the specific example described above and illustrated in FIG. 6, showing how the system 100 could be configured to pick the right bits out of the word to obtain most of the information required. In FIG. 7, again, a binary representation of the input value x=1999 is shown as a value 700. The configuration information provided to the system 100 could indicate that the number of bit to be extracted from the binary representation of the input value to determine the fraction are the 9 least significant bits of the binary representation of the input value, indicated as N_{f} 704 in FIG. 7 (analogous to 604 in FIG. 6) and that the number of bits to be extracted from the binary representation of the input value to determine the index are the 3 bits preceding the 9 least significant bits of the binary representation of the input value, indicated as Nᵢ 702 in FIG. 7 (analogous to 602 in FIG. 6). The configuration information could also indicate that if the input value has any non-zero bit preceding the indicated number of bits to be extracted for determining the index, then the input value is over the range of the values available in the lookup table. In the current example, this would mean that the configuration information would indicate that if the binary representation of the input value contains any non-zero bits preceding the 12 least significant bits (i.e. 3 bits for the index and 9 bits for the fraction, in this example), then the input value is over range. In the current example, the binary representation only contains zero-bits as bits preceding the 12 LSBs, shown as MSBs 706, which means that the input value x=1999 is not over range, which is correct.

Now that the system 100 has obtained information as to which bits in the binary representation represent the index and the fraction, the system 100 can extract those bits to determine the index and the fraction. The extraction may be carried out using shifters, as described below.

Since the 9 LSBs represent the fraction and only after that the 3 bits representing the index follow, in order to determine the table index, the system 100 would be configured to right-shift the binary representation of the input value by 9 bits, to eliminate the bits representing the fraction, which would result in value shown as 708 in FIG. 7. For x=1999, the value resulting in this shift is 011_{binary} which is 3 in decimal, indicating that the index in the table is 3.

Since the 3 bits preceding the 9 LSBs represent the index, in order to determine the table fraction, the system 100 would be configured to left-shift the binary representation of the input value by a number of bits until the 9 LSBs immediately follow position of binary point for fractional binary representation, shown as position 710 in FIG. 7. In this example implementation, the fraction is represented using 15 fractional bits (which could also be provided to system 100 as part of the configuration information), and the system is configured to zero-pad the rest of the LSB bits, i.e. place zeros in the remaining 6 LSBs. A value representing the fraction in this example is illustrated in FIG. 7 as a value 712, where, following the binary point 710 for fractional binary representation, 9 fraction bits from the binary representation of the input value follow, shown as bits 714 (the same bits as in 704), and after that the rest of the LSBs are zero-padded, as shown with 6 zero-padded LSBs 716. If converted to decimal, the binary representation 712 would be 0.904296875, which is the correct fraction for the input value x=1999 for the lookup table including 8 entries with x values in the range from x₀=0 to x_{N}=4096.

In practice, many of the parameters would be configurable, the index may be further processed to generate the address in memory, and the fraction may be further processed and made suitable for interpolation arithmetic (include making available in a SIMD format).

### Additional Illustrations of Index and Fraction Determination and Use

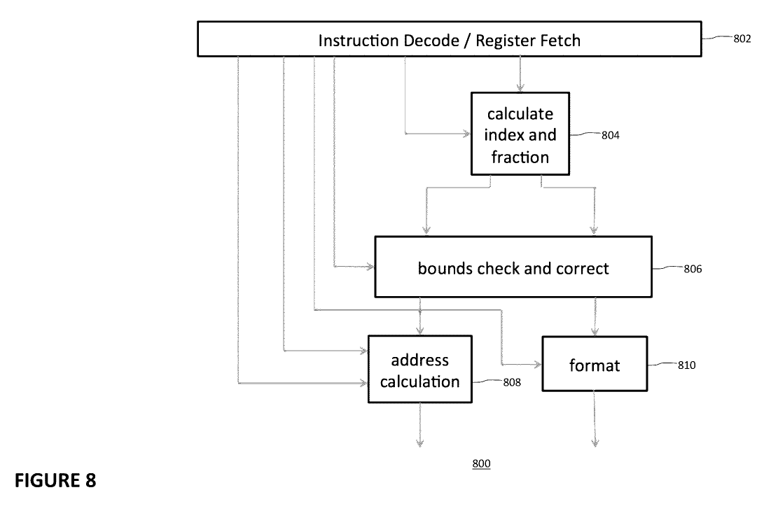

FIG. 8 is a flow diagram illustrating provision of table address and fraction, according to some embodiments of the present disclosure. FIG. 8 illustrates a flow 800 from the top to the bottom of the FIGURE. In the general case, the table start address and the configuration information is made available by the instruction decode and register fetch logic 802, which could be implemented within the system 100 described above as a logic that is not specifically shown but that could be implemented as, or in, the computer system 200 of FIG. 2. This information is either encoded in the opcode running in the logic 802 or is received by the logic 802 from registers, or both. This information together with the input x is used, in step 804, to calculate preliminary index and fraction values, e.g. using the index determination logic 102 and the fraction determination logic 104 shown in FIG. 1. The preliminary index and fraction are provided to step 806, where the preliminary index value is checked for being within the table range. If the input is out of range then the index and fraction values may be corrected by modifying them to bring them inside the valid range. Finally an address calculation may be performed (step 808), and the output fraction may be brought into the desired format by the (step 810).

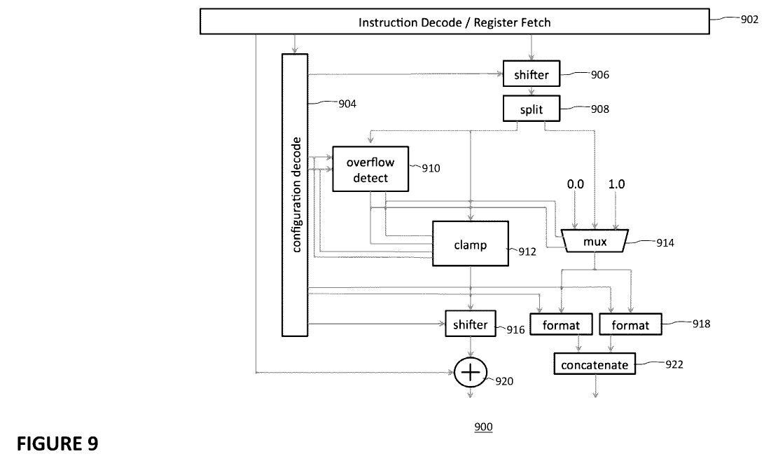

FIG. 9 is a flow diagram 900 illustrating provision of table index and fraction, according to some embodiments of the present disclosure. As with FIG. 8, the flow in FIG. 9 is from the top to the bottom. When the instruction decode/register fetch logic 902 (analogous to logic 802 described above) encounters a table_index instruction, the logic 902 makes available to the rest of the algorithm shown in FIG. 9 the table_start_address, configuration information, the value of x (i.e. the input to the function calculation).

The configuration information is decoded by the configuration decode logic 904, which is not specifically shown in FIG. 1 but could be implemented as, or in, the computer system 200 described above. This can be as simple as extracting bits from a binary word that is configured to present configuration information. In some implementations, the table_start_address and the configuration information originate from registers that are loaded prior to the table_index instruction. Alternatively, some or all of this information could be encoded in the table_index opcode stored in the logic 902/system 100.

The logic 902 performs sign extension and zero padding of the input value x, and the outcome is provided as an input to the shifter 906. The shifter right shifts by N_{f}, a number taken from the decoded configuration. The output of the shifter is split into two words (step 908), one being the preliminary index, and one being the preliminary fraction.

The preliminary_index optionally has 2^{N}^{ᵢ} added in the case that the input is bipolar. The result of this optional addition is then checked to see if it in the range of the table (step 910) and then clamped accordingly (step 912). To that end, if the function is not periodic and the index is too high, the signal clamp_high becomes true, and if it is too low (negative), then signal clamp_low becomes true. If the index is within the table or the function is to be periodically extended, then both clamp_high and clamp_low will be false.

In this implementation, the final index is always with in range 0≦index<N, regardless of the input being in range, or the input being negative.

When input variable x is within the range of the table, the multiplexer 914 selects the fraction computed by 908. When x is too large, the multiplexer 914 selects the value 1.0, which is the largest value allowed for the fraction. When x is too low, the multiplexer 914 selects the value 0.0, which is lowest value allowed for the fraction.

In this implementation, the fraction computed by 914 is further formatted by two blocks 918 and these reformatted numbers are concatenated by block 922 to form a word compatible with the SIMD instructions of the processor.

The index value computed by 912 is shifted by an amount determined by the configuration decode 904. This performs the multiplication required to implement equation (4) where table_entry_size is restricted to powers of two. Finally the adder 920 performs the addition required to implement equation (4).

The result of all of the calculations in 900 is an address within the table and a fraction represented in a form suitable for the SIMD processor.

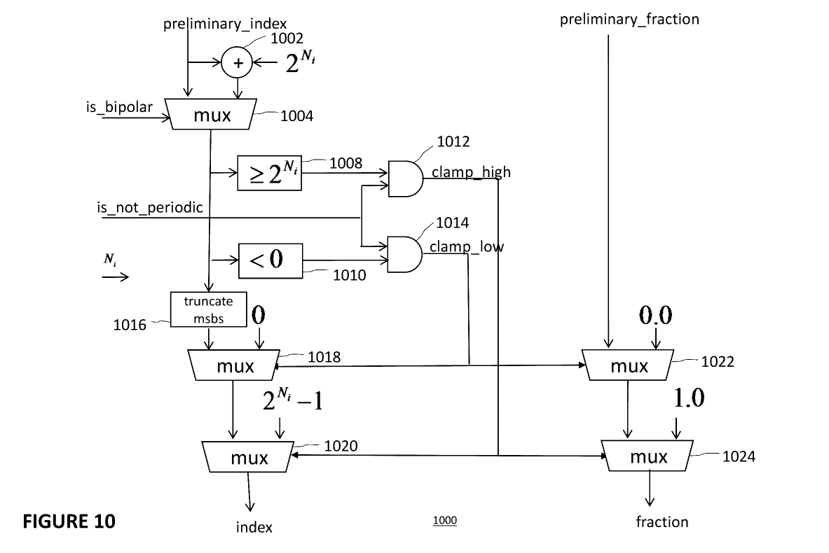

FIG. 10 is a flow diagram 1000 illustrating a more detailed diagram of clamp detection and clamp muxing, according to some embodiments of the present disclosure. As shown in FIG. 10, the logic required to implement 900 may include an adder, a number of multiplexers, magnitude comparisons and simple Boolean logic. The input preliminary_index is computed by 908. An adder 1002 implements the addition required for the case of bipolar input range to ensure that the index range starts from zero. This is selected by a multiplexer 1004 when the signal is_bipolar from the configuration decode logic 904 is true. The output of the multiplexer 1004 should be within the range 0.2^{Ni}−1 and this is checked by magnitude comparators 1008 and 1010. The logic in 1016 zeros out the most significant bits of its input to ensure that the output only has Nᵢ active bits. This may cause wrap around, which is the desired behavior when periodic extension is required (i.e. when the signal is_not_periodic is false). When the signal is_not_periodic is true, the desired behavior is clamp. The AND gates 1012 and 1014 ensure that the clamp signals clamp_high and clamp_low are only active when is_not_periodic is true. A multiplexer 1018 selects 0 for the case of clamp_low being active and multiplexer 1020 selects 2^{Ni}−1 for the case that clamp_high is true. The output of multiplexer 1020 forms the input to 916. The clamp_low and clamp_high signals are also used to drive the fraction obtained from 908 to 0.0 and 1.0 respectively using multiplexers 1022 and 1024 respectively.

FIG. 10 provides just one example of possible clamp detection and mixing. A person of ordinary skill in the art could envision other ways of performing this function, based on the descriptions provided herein, all other ways being also within the scope of the present disclosure.

### Additional Information on “Formats”

The basic table_index instruction outputs a fraction. There can be number of options on how to use this information.

The fraction can be considered to be a number between 0 and 1. This can be encoded as a signed number with the sign bit set to zero. Alternatively it could be formatted as an unsigned number where the MSB bit represents one half. For example, “1.15” signed number “0.xxx xxxx xxxx xxxx” while “0.16” unsigned numbered “.xxxx xxxx xxxx xxxx”

For some interpolation algorithms, the coefficient (1-fraction) may be required. This simple calculation may be also performed by the format block to save processor instructions.

For linear interpolation, the straight line segment has equation

$${f}_{approx} ( {x}_{index} , fraction ) ≅ ( 1 - fraction ) * f ( {x}_{index} ) + fraction * f ( {x}_{index + 1} )$$

$$fraction = \frac{( x - {x}_{index} )}{{x}_{spacing}}$$

where index and fraction are returned from the table_index instruction and where f(x_{index}) and f(x_{index+1}) are the function values stored in the table.

For a SIMD processor, it can be possible to load both f(x_{index}) and f(x_{index+1}) together into a register pair. Using the dual format capability of the implementation, it is possible to generate the corresponding coefficient pair, (1−fraction) and fraction and then use a SIMD multiply instruction to perform the two multiplications.

All of the explanations provided above may be extended to process two and more input data values at a time, which is within the scope of the present disclosure.

### Variations and Implementations

While embodiments of the present disclosure were described above with references to exemplary implementations as shown in FIGS. 1-12, a person skilled in the art will realize that the various teachings described above are applicable to a large variety of other implementations. For example, the general teachings described herein are applicable to both floating point and fixed point instructions, with the differences in each particular implementation being apparent to a person skilled in the art. In another example, while the teachings provided herein referred specifically to function computation based on a single input value, the systems and methods described herein could be configured to perform similar computations for functions that take two or more input values.

In certain contexts, the features discussed herein can be applicable to automotive systems, medical systems, scientific instrumentation, wireless and wired communications, radar, industrial process control, audio and video equipment, current sensing, instrumentation (which can be highly precise), and other digital-processing-based systems.

Moreover, certain embodiments discussed above can be provisioned in digital signal processing technologies for medical imaging, patient monitoring, medical instrumentation, and home healthcare. This could include pulmonary monitors, accelerometers, heart rate monitors, pacemakers, etc. Other applications can involve automotive technologies for safety systems (e.g., stability control systems, driver assistance systems, braking systems, infotainment and interior applications of any kind).

In yet other example scenarios, the teachings of the present disclosure can be applicable in the industrial markets that include process control systems that help drive productivity, energy efficiency, and reliability. In consumer applications, the teachings of the signal processing circuits discussed above can be used for image processing, auto focus, and image stabilization (e.g., for digital still cameras, camcorders, etc.). Other consumer applications can include audio and video processors for home theater systems, DVD recorders, and high-definition televisions.

In the discussions of the embodiments above, components of a system, such as e.g. clocks, multiplexers, buffers, and/or other components can readily be replaced, substituted, or otherwise modified in order to accommodate particular circuitry needs. Moreover, it should be noted that the use of complementary electronic devices, hardware, software, etc. offer an equally viable option for implementing the teachings of the present disclosure.

Parts of various systems for determining table index and fraction, and possibly table address, can include electronic circuitry to perform the functions described herein. In some cases, one or more parts of the system can be provided by a processor specially configured for carrying out the functions described herein. For instance, the processor may include one or more application specific components, or may include programmable logic gates which are configured to carry out the functions describe herein. The circuitry can operate in analog domain, digital domain, or in a mixed signal domain. In some instances, the processor may be configured to carrying out the functions described herein by executing one or more instructions stored on a non-transitory computer readable storage medium.

In one example embodiment, any number of electrical circuits of FIGS. 1-12 may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

In another example embodiment, the electrical circuits of FIGS. 1-12 may be implemented as stand-alone modules (e.g., a device with associated components and circuitry configured to perform a specific application or function) or implemented as plug-in modules into application specific hardware of electronic devices. Note that particular embodiments of the present disclosure may be readily included in a system on chip (SOC) package, either in part, or in whole. An SOC represents an IC that integrates components of a computer or other electronic system into a single chip. It may contain digital, analog, mixed-signal, and often radio frequency functions: all of which may be provided on a single chip substrate. Other embodiments may include a multi-chip-module (MCM), with a plurality of separate ICs located within a single electronic package and configured to interact closely with each other through the electronic package. In various other embodiments, the functionalities of extended log and exp circuits may be implemented in one or more silicon cores in Application Specific Integrated Circuits (ASICs), Field Programmable Gate Arrays (FPGAs), and other semiconductor chips.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular processor and/or component arrangements. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of FIGS. 1-12 may be combined in various possible configurations, all of which are clearly within the broad scope of this Specification. In certain cases, it may be easier to describe one or more of the functionalities of a given set of flows by only referencing a limited number of electrical elements. It should be appreciated that the electrical circuits of FIGS. 1-12 and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

It is also important to note that the functions related to determination of table index and fraction, and possibly memory address, illustrate only some of the possible functions that may be executed by, or within, system illustrated in FIGS. 1-12. Some of these operations may be deleted or removed where appropriate, or these operations may be modified or changed considerably without departing from the scope of the present disclosure. In addition, the timing of these operations may be altered considerably. The preceding operational flows have been offered for purposes of example and discussion. Substantial flexibility is provided by embodiments described herein in that any suitable arrangements, chronologies, configurations, and timing mechanisms may be provided without departing from the teachings of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

Note that all optional features of the apparatus described above may also be implemented with respect to the method or process described herein and specifics in the examples may be used anywhere in one or more embodiments.

Although the claims are presented in single dependency format in the style used before the USPTO, it should be understood that any claim can depend on and be combined with any preceding claim of the same type unless that is clearly technically infeasible.

What is claimed is:

1. An apparatus for at least determining a table index and a fraction to be used in computing a function of an input variable using a lookup table, the apparatus comprising:
logic for receiving the input variable, configuration information for the lookup table, and a memory address of a predefined reference point within the lookup table;
logic for sign extending the input value;
logic for zero padding the input value for the input value to be a binary value comprising a predefined number of bits;
logic for using the configuration information to determine a first number of bits to shift a binary representation of the input variable to determine the table index;
logic for using the configuration information to determine a second number of bits to shift the binary representation of the input variable to determine the fraction;
one or more shifters for shifting the binary representation of the input variable by the first number of bits to determine the table index and for shifting the binary representation of the input variable by the second number of bits to determine the fraction;
logic for using the memory address of the predefined reference point and the determined table index to determine a memory address from which a table value for computing the function is to be obtained; and
logic for providing as an output the memory address from which the table value for computing the function is to be obtained and the fraction.

2. The apparatus according to claim 1, wherein the configuration information and the memory address of the predefined reference point within the lookup table are obtained from one or more registers.

3. The apparatus according to claim 2, wherein the one or more registers are loaded prior to the receipt of the input variable.

4. The apparatus according to claim 1, wherein the predefined reference point comprises a starting value of the lookup table.

5. An apparatus for at least determining a table index and a fraction to be used in computing a function of an input variable using a lookup table, the apparatus comprising:
logic for obtaining configuration information for the lookup table;
logic for using the configuration information to determine a first number of bits to shift a binary representation of the input variable to determine the table index;
logic for using the configuration information to determine a second number of bits to shift the binary representation of the input variable to determine the fraction; and
one or more shifters for shifting the binary representation of the input variable by the first number of bits to determine the table index and for shifting the binary representation of the input variable by the second number of bits to determine the fraction.

6. The apparatus according to claim 5, wherein the configuration information comprises:
an indication of a number of bits to be extracted from the binary representation of the input variable to determine the table index, and
an indication of a number of bits to be extracted from the binary representation of the input variable to determine the fraction.

7. The apparatus according to claim 5, wherein the configuration information further comprises one or more of: an indication of whether a range of input variables of the lookup table comprises only positive input variable or whether the range is centered around zero, an indication whether the function is to be periodically extended outside of the range, an indication of an amount of memory space allocated for storing each table entry, and a format indicating how the fraction is to be presented.

8. The apparatus according to claim 5, further comprising:
logic for obtaining a memory address of a predefined reference point within the lookup table; and
logic for using the memory address of the predefined reference point and the determined table index to determine a memory address from which a table value for computing the function is to be obtained.

9. The apparatus according to claim 8, wherein the predefined reference point comprises a starting value of the lookup table.

10. The apparatus according to claim 5, further comprising:
logic for providing as an output at least two representations of the determined fraction.

11. The apparatus according to claim 10, wherein:
a first representation of the at least two representations of the determined fraction provides a fraction to be used in computing the function of the input variable using a table value of the lookup table indexed by the determined index, and
a second representation of the at least two representations of the determined fraction provides a fraction to be used in computing the function of the input variable using a table value of the lookup table immediately following or immediately preceding the table value indexed by the determined index.

12. The apparatus according to claim 5, further comprising:
logic for determining whether the input variable is within a range of input variables of the lookup table;
logic for providing an indication when the input variable is determined to be outside of the range and the function is not to be periodically extended outside of the range; and
logic for providing an indication on computing a value to be used in computing the function based on the determined table index when the input variable is determined to be outside of the range and the function is to be periodically extended outside of the range.

13. The apparatus according to claim 5, further comprising:
logic for computing the function using the determined table index and the determined fraction.

14. The apparatus according to claim 5, wherein the input variable is a floating point number.

15. The apparatus according to claim 5, wherein the input variable is a fixed point number.

16. The apparatus according to claim 5, wherein the apparatus is implemented in an application specific integrated circuit (ASIC), a programmable gate array (PGA), or a digital signal processor (DSP).

17. A non-transitory computer readable storage medium storing one or more computer readable instructions which, when executed on a processor, configure the processor to carry out a method or at least determining a table index and a fraction to be used in computing a function of an input variable using a lookup table, the method comprising:
obtaining configuration information for the lookup table;
using the configuration information to determine a first number of bits to shift a binary representation of the input variable to determine the table index;
using the configuration information to determine a second number of bits to shift the binary representation of the input variable to determine the fraction; and
shifting the binary representation of the input variable by the first number of bits to determine the table index and for shifting the binary representation of the input variable by the second number of bits to determine the fraction.

18. The non-transitory computer readable storage medium according to claim 17, wherein the method further comprises:
obtaining a memory address of a predefined reference point within the lookup table; and
using the memory address of the predefined reference point and the determined table index to determine a memory address from which a table value for computing the function is to be obtained.

19. The non-transitory computer readable storage medium according to claim 17, wherein the method further comprises providing as an output at least two representations of the determined fraction.

20. The non-transitory computer readable storage medium according to claim 19, wherein:
a first representation of the at least two representations of the determined fraction provides a fraction to be used in computing the function of the input variable using a table value of the lookup table indexed by the determined index, and
a second representation of the at least two representations of the determined fraction provides a fraction to be used in computing the function of the input variable using a table value of the lookup table immediately following or immediately preceding the table value indexed by the determined index.
